(19) United States
(12) Patent Application Publication
(10) Pub. No.: US 2014/0272079 A1
(43) Pub. Date: Sep. 18, 2014

(54) COFFEE COMPRISING CHINESE HERBS FOR LOWERING BLOOD SUGAR OF WEAK-BLADDER BODY TYPE PERSONS

(71) Applicant: Bo-Mi Sim, Gangneung (KR)

(72) Inventor: Bo-Mi Sim, Gangneung (KR)

(21) Appl. No.: 13/856,828

(22) Filed: Apr. 4, 2013

(30) Foreign Application Priority Data
Mar. 14, 2013 (KR) 10-2013-27115

(51) Int. Cl. A23F 5/14

(52) U.S. Cl. CPC A23F 5/14
USPC 426/595

(57) ABSTRACT

Provided is a coffee composition that is suitably prepared for weak-stomach body type persons and may lower the body sugar, in which the coffee composition includes a powder or granule mixture of 14.00% by weight of coffee powder, 10.0% by weight of Job's tears powder, 2.0% by weight of mulberry bark powder, 6.0% by weight of Solomon's seal powder, 29.4% by weight of non-dairy creamer powder, 26.0% by weight of milk powder, 12.0% by weight of brown sugar, and 0.6% by weight of honey.

### CROSS-REFERENCE TO RELATED APPLICATIONS

This application claims priority to and the benefit of Korean Patent Application No. 10-2013-27115 filed in the Korean Intellectual Property Office on Mar. 14, 2013, the entire contents of which are incorporated herein by reference.

### TECHNICAL FIELD

The present invention relates to a coffee for lowering blood sugar of weak-bladder body type persons. More particularly, the present invention relates to a coffee for lowering blood sugar of weak-bladder body type persons, which is prepared differently according to two types of physical constitutions divided based on the function of organs that are involved in digestion and absorption to lower the blood sugar while a diabetic patient enjoys coffee which is responsible for an increase in blood sugar such that a diabetic patient with the weak-bladder type physical constitution drinks and enjoys the coffee.

### BACKGROUND ART

As a standard of living has been recently improved, the consumption of high-calorie fatty foods is increasing whereas the consumption of low-calorie fibrous foods is decreasing, and thus the number of patients suffering from constipation is increasing. Examples of the symptoms of constipation include a decrease in the amount of feces or the number of defecations, difficulty in defecation caused by hardened feces, and suffering from defecation.

Ingested food is usually excreted as feces after 12 hours, but the amount of feces or the number of defecations is greatly affected by the content of fiber in the ingested food.

When a highly fibrous food is ingested, fiber while not digested in the intestine absorbs liquid to increase the volume thereof, thereby increasing the amount of excretion and also softening the form of excretion. In this case, the organ receives a stimulus appropriate for excretion, thereby facilitating defecation.

The defecating activity is greatly affected by how active the organs that constitute the digestive system are. Among the organs, the functions of the stomach, bladder, and colon greatly affect the defecating activity, and thus when the movement thereof becomes too insensitive or too sensitive, constipation symptoms may be caused. When the constipation symptoms become severe as the functions of the bladder and colon become insensitive whereas the stomach's function is smooth, the symptoms frequently occur to people with obesity physical constitution, whose body metabolic process is slow, and conversely, when the constipation symptoms become severe as the stomach's function becomes weak and the functions of the bladder and colon become sensitive, the symptoms frequently occur to people with thin physical constitution, who are suffering from constipation and diarrhea alternately.

Currently, various functional foods and drugs for alleviating these constipation symptoms are commercially available, but there is a problem in that these foods and drugs are generally prescribed to constipated patients without considering the causes of the occurrence of constipation with various aspects. For example, the simple supplement of dietary fibers increases the amount of feces and promotes the function of the intestines, and thus may help constipation symptoms to be temporarily alleviated, but there is a limitation in correcting the physiological imbalance that causes constipation from the source thereof according to the physical constitution of a patient with constipation. Further, in the case of a drug that temporarily increases the bowel movement, constipation symptoms may be immediately alleviated by causing the movement of bowels artificially, but when the drug is repeatedly used, more severe side effects may be caused by constricting the original bowel movement that occur according to the physiological activities.

### SUMMARY OF THE INVENTION

The present invention has been made in an effort to provide a coffee for lowering blood sugar of weak-bladder body type persons, which may lower blood sugar while people with a physical constitution in which the functions of the bladder and colon are more insensitive than the stomach's function (hereinafter referred to as ‘weak-bladder body type persons’) enjoys coffee which is responsible for an increase in blood sugar by producing the coffee according to a physical constitution of people, in which individual's physical constitutions are divided into two types according to the function of the organs that are involved in digestion and absorption and the coffee is produced differently according to each individual's physical constitution to lower the blood sugar while a diabetic patient with the weak-bladder type physical constitution enjoys the coffee which is responsible for an increase in blood sugar so that the diabetic patient drinks and enjoys the coffee.

An exemplary embodiment of the present invention provides a coffee for lowering sugar blood of weak-bladder body type persons, whose stomach's function is relatively stronger than the functions of the bladder and colon, in which the coffee includes 13.00% by weight of coffee powder, 9.0% by weight of Job's tears powder, 2.2% by weight of mulberry bark powder, 7.0% by weight of Solomon's seal powder, 25.5% by weight of non-dairy creamer powder, 27.8% by weight of milk powder, 15.0% by weight of brown sugar, and 0.5% by weight of honey.

Preferably provided is a coffee for lowering sugar blood of the weak-bladder body type persons, in which the mulberry bark powder, Job's tears powder, and Solomon's seal powder are subjected to a powderization process of pouring water 15 times, 10 times and 10 times of weight of the mulberry bark powder, Job's tears powder, and Solomon's seal powder, respectively, and performing vacuum heating of the mixture at 105° C. for 7 hours for 3 to 4 days.

When functions are largely classified into two types according to the function of human organs, people are classified into the weak-stomach body type persons and the weak-bladder body type persons, and thus, the present invention is advantageous in that a diabetic patient with the weak-bladder body type drinks and enjoys comfortably the coffee by differently producing the coffee according to each individual's physical constitution to lower the blood sugar while the diabetic patient also enjoys coffee which is responsible for an increase in blood sugar.

### DETAILED DESCRIPTION

A health food for alleviating constipation according to the present invention provides a coffee for lowering blood sugar of the weak-bladder body type persons, which is appropriate for individual's physical constitutions which are classified into two types according to the relative activity of the organs that are involved in digestion and defecation.

In particular, the present invention provides a coffee for lowering blood sugar of weak-bladder body type persons, whose stomach's function is relatively stronger than the functions of bladder and colon thereof.

When coffee is mixed in different contents with different medicines according to each physical constitution such as weak stomach physical constitution, weak bladder physical constitution, or the like, a significantly high efficiency of lowering blood sugar is exhibited compared to the case in which physical constitutions are not classified.

The present inventors have conducted studies on foods which are helpful for the health of people, and found that when human physical constitutions are largely classified into two types according to the relative activity of physiological functions of the bladder and colon compared to the stomach and then dietary therapy is recommended according to each physical constitution, it is possible to lead a healthy life, and as a result, the present inventors published these findings as a book (“For Health” published by Sambo Jungsa, Mar. 3, 2008).

According to the book, there is a case in which the functions of the bladder and colon are weaker than the stomach's function according to each individual's physical constitution, and there is the opposite case. In the present invention, those who belong to the former are defined as the weak-bladder body type persons, and those who belong to the latter are defined as the weak-stomach body type person. Patients with constipation are classified into two groups of physical constitutions according to the definitions, and each of the health food compositions for alleviating constipation was developed according to the group of physical constitutions.

The weak-bladder body type persons usually correspond to people with an obese body frame. People corresponding to the physical constitution have the functions of the bladder and colon, which are relatively weaker than the stomach's function, and have slow body's metabolic functions, and thus have a physical constitution to gain weight easily even while eating a small amount of food, and to easily get ill due to weak bladder and colon.

Accordingly, when a weak-bladder body type person comes down with constipation, the symptoms thereof are effectively alleviated by taking health foods having a function of reinforcing the functions of the bladder and colon.

On the contrary, weak-stomach body type persons usually correspond to people with a thin body frame. People corresponding to the physical constitution have the stomach's function, which is relatively weaker than the functions of the bladder and colon thereof, and have active body's metabolic functions, and thus have a physical constitution in which it is difficult to gain weight even while eating a large amount of food and it is easy to get ill due to a weak stomach. Accordingly, when a weak-stomach body type person comes down with constipation, the symptoms thereof are effectively alleviated by taking health foods having a function of reinforcing the stomach's function.

At this time, the definition of an obese body frame or a thin body frame is usually based on a judgment from an outward appearance, but the reference for the judgment from an outward appearance is also likely to be based on a personal ground, and thus the present invention provides a more objective reference for classification of the body frame and it will be preferable to take a coffee for lowering blood sugar, which is appropriate for a physical constitution of each body frame.

Standard weight=(Height cm−100)×0.9 [Formula 1]

Normal weight=Standard weight×±5 kg

Degree of obesity(%)=Current weight(kg)/Standard weight(kg)

Normal=Degree of obesity is 90 to 110%

Overweight=Degree of obesity is 110 to 120%

Obese=Degree of obesity is 120 to 140%

Low weight=Degree of obesity is 90% or less

Accordingly, as a method of classifying physical constitutions based on an objective reference, it is preferable to group people who are obese into the weak-bladder body type persons by measuring the degree of obesity thereof.

In addition, as a method of classifying the physical constitutions of people, there is a method of identifying the status of the body according to the ingestion of food. For example, a weak-bladder body type person may digest cold food such as naengmyeon (cold noodle) well, but a weak-stomach body type person does not digest the food well. Furthermore, the weak-bladder body type person may absorb pork better than beef, but the weak-stomach body type person has an opposite result. The weak-bladder body type person digests beer better than soju, and the weak-stomach body type person digests soju better than beer. Of course, this does not mean habitual preference or familiarity. Further, as a method of classifying physical constitutions, people, who do not digest food well when they are nervous or under high stress, are defined as the weak-stomach body type persons, and people, who digest food well regardless of whether they are nervous or under high stress, are defined as the weak-bladder body type persons. In addition, people, who may eat a spoonful or more of cooked rice even when they are full up, are defined as the weak-bladder body type persons, and people, who fail to do so, are defined as the weak-stomach body type persons.

Meanwhile, coffee is one of the main foods which increase the blood sugar, and patients with diabetes do not drink coffee regardless of their physical constitutions even though the patients want to.

Accordingly, when coffee, which is mixed with a Korean herbal medicine having a very high ratio of lowering blood sugar, the mixture is drunk in an appropriate ratio, the coffee may be enjoyed and blood sugar may also be lowered, which is preferred.

At this time, when the contents of the medicine mixed are classified for each physical constitution and the coffee is prepared, an even higher ratio of lowering blood sugar may be expected.

According to the present invention, the coffee for lowering blood sugar for a weak-bladder body type person is composed of a composition obtained by mixing coffee powder, Job's tears powder, mulberry bark powder, and Solomon's seal powder as a basic mixture, and mixing honey, brown sugar, milk, and non-dairy creamer with the basic mixture.

The mixed compositions may be provided as powder or granule. When the compositions are provided as granule, the compositions may be provided by using a special production method of mixing the ingredients in granule form without using an adhesive ingredient instead of using a method of adding an edible adhesive ingredient such as starch and compressing the mixture as in the health functional food in the related art.

Job's tear, which is included in the coffee for lowering blood sugar for a weak-bladder body type person according to the present invention contains many nutrients and includes large amounts of lipids, iron, zinc, calcium, vitamin e, and protein in addition to fibers, and also a large amount of unsaturated fatty acids.

Examples of the efficacy of Job's tear include alleviation of arteriosclerosis, body's sugar control, prevention of aging, suppression of diabetes, anticancer action, infertility alleviation, and reinforcement of bowel functions.

Specifically, the content of Job's tears powder in the coffee for lowering blood sugar for weak-bladder body type persons is preferably 9.0% by weight.

Meanwhile, mulberry bark powder, which is included in the coffee for lowering blood sugar of a weak-bladder body type person according to the present invention is powdered mulberry bark, and mulberry bark is the root skin of mulberry and also called Morus bombycis Koidzumi. Mulberry trees were artificially cultivated in the past in order to feed silkworms, and wild mulberry trees are grown in mountains, but from the viewpoint of medicinal properties, wild mulberry trees are better.

Mulberry bark is rated as excellent when the color is white and the flesh is thick and flexible. Mulberry bark has a sweet taste, removes the lung fire, stops coughing, clears the lung energy, and is used as an anti-inflammatory diuresis, antipyresis and antitussive medicine for the treatment of symptoms such as bronchitis, hematemesis, dropsy, blister and the like.

That is, mulberry bark is also taken by people with weak lungs, but has physiologically active actions such as alleviating constipation, diuretic action and the like, and thus is beneficial when included in the composition of the present invention regardless of physical constitutions. Specifically, the content of mulberry bark powder in the coffee for lowering blood sugar for weak-bladder body type persons is preferably 2.2% by weight.

Solomon's seal powder included in the coffee for lowering blood sugar of weak-bladder body type persons according to the present invention has an effect of quenching thirst and preventing heat prostration, shows excellent efficacy in back pain, fever and bruise, and has efficacy of easing five organs when the powder is taken for a long period. Further, Solomon's seal has an effect against vascular diseases, normalizes the blood sugar level, and thus has efficacy against diabetes.

Solomon's seal protects spleen, stomach, and lungs, and thus is useful for weak-bladder body type persons and also for weak-stomach body type persons. Solomon's seal is produced in powder form by obtaining the rhizome in the spring or autumn, removing the trunk, washing the remaining part with clean water, trimming the rootlets, steaming the resultant part with steam as a first step, lyophilizing the part as a second step, and then grinding the lyophilized part.

Specifically, the content of Solomon's seal powder in the coffee for lowering blood sugar for weak-bladder body type persons is preferably 7.0% by weight.

At this time, the present invention is for a coffee for lowering blood sugar of weak-bladder body type persons, who have stomach functions relatively stronger than the bladder and colon, and it is preferred that the mulberry bark powder, Job's tears powder, and Solomon's seal powder are subjected to a powderization process of pouring water 15 times, 10 times and 10 times of weight of the mulberry bark powder, Job's tears powder, and Solomon's seal powder, respectively, and performing vacuum heating of the mixture at 105° C. for 7 hours for 3 to 4 days.

Meanwhile, non-dairy creamer, which is an additional ingredient of the coffee for lowering blood sugar of weak-bladder body type persons, is an additive in powder form, which is put into coffee. Non-dairy creamer is widely used as a substitute for creamer (obtained from milk).

Non-dairy creamer included in the composition of the present invention is present in an amount of preferably 25.5% by weight.

In addition, honey and brown sugar, which are additional ingredients to the coffee for lowering blood sugar for weak-bladder body type persons, are present in amounts of 0.5% by weight and 15.0% by weight, respectively, and are widely known materials, and thus a detailed description thereof will be omitted.

Hereinafter, the present invention will be described in detail through the Examples. These Examples are illustrative only for application of the present invention, and should not be interpreted in a limiting sense.

### Example 1

### Classification of Experimental Subjects into Physical Constitutions

Selection of weak-bladder body type persons: People, who were usually weigh more than the considered normal average, had wide shoulders and a quick temper, had a physical constitution to easily get ill due to weak bladder and had the functions of the organs located on the right side of the body, which were relatively weaker than the stomach function and slow body's metabolic functions, and thus had a physical constitution to gain weight easily even though eating a small amount of food, were selected as weak-bladder body type persons.

Selection of weak-stomach body type persons: People of this body type are usually slim, and have a physical constitution to easily get ill due to a weak stomach. According to the definition of weak-stomach body type persons in the present invention, people, who had active body's metabolic functions whereas the stomach's function was relatively weaker than the functions of the bladder and colon, and thus had a physical constitution to gain weight with difficulty even though eating a large amount of food in consideration of the dietary habit and body frame of the volunteers, were classified into weak-stomach body type persons. As a result of classifying 160 volunteers who visited the present inventors, it was determined that 62.5% of the volunteers were weak-bladder body type persons, and 37.5% were weak-stomach body type persons.

The classification according to the physical constitution was performed by using Formula 1 as described above as a reference.

### Example 2

### Preparation Example of Coffee for Lowering Blood Sugar of Weak-Bladder Body Type Persons

A powder mixture was prepared, the mixture including: 13.00% by weight of coffee powder, 9.0% by weight of Job's tears powder, 2.2% by weight of mulberry bark powder, 7.0% by weight of Solomon's seal powder, 25.5% by weight of non-dairy creamer powder, 27.8% by weight of milk powder, 15.0% by weight of brown sugar, and 0.5% by weight of honey, and then an effect of lowering blood sugar was tested according to the method in the following Example 3.

### Example 3

### Method of Testing Effect of Lowering Blood Sugar

A coffee composition prepared by using the optimal blending ratio of the coffee for lowering blood sugar for weak-bladder body type persons according to the present invention may be powdered and mixed with water, and the mixture may be drunk. In this case, 15 g of the coffee composition is mixed with water to constitute a mug cup (about 200 ml), and as a result of administering the coffee composition orally to weak-stomach body type persons, an excellent ratio result of lowering blood sugar was exhibited.

TABLE 1

| | | | Blood sugar | Variation in blood | | |
|---|---|---|---|---|---|---|
| | | | level before | sugar level with time | | |
| | | | taking coffee | after taking coffee | | |
| | | Physical | composition | composition (mg/dl) | | |
| Sex | Age | constitution | (mg/dl) | 30 Min | 45 Min | 60 Min |
| Female | 49 | Weak-bladder | 131 | 121 | — | — |
| | | body type | | | | |
| | | person | | | | |
| Female | 64 | Weak-bladder | 179 | 193 | 205 | 196 (long |
| | | body type | | | | hospitalized |
| | | person | | | | patient) |
| Female | 58 | Weak-bladder | 122 | 111 | — | — |
| | | body type | | | | |
| | | person | | | | |
| Female | 60 | Weak-bladder | 132 | 115 | — | — |
| | | body type | | | | |
| | | person | | | | |
| Female | 58 | Weak-bladder | 109 | 102 | — | — |
| | | body type | | | | |
| | | person | | | | |
| Male | 66 | Weak-bladder | 178 | 147 | — | — |
| | | body type | | | | |
| | | person | | | | |

Meanwhile, the natural food composition for alleviating constipation of weak-bladder body type persons according to the embodiments of the present invention is not limited to the aforementioned embodiments, and various modifications are possible within the scope without departing from the technical gist thereof.

What is claimed is:

1. A coffee for lowering blood sugar of weak-bladder body type persons, whose stomach's function is relatively stronger than the functions of the bladder and colon thereof, wherein the coffee comprises 13.00% by weight of coffee powder, 9.0% by weight of Job's tears powder, 2.2% by weight of mulberry bark powder, 7.0% by weight of Solomon's seal powder, 25.5% by weight of non-dairy creamer powder, 27.8% by weight of milk powder, 15.0% by weight of brown sugar, and 0.5% by weight of honey.

2. The coffee for lowering blood sugar of weak-bladder body type persons of claim 1, wherein the mulberry bark powder, Job's tears powder, and Solomon's seal powder are subjected to a powderization process of pouring water 15 times, 10 times and 10 times of weight of the mulberry bark powder, Job's tears powder, and Solomon's seal powder, respectively, and performing vacuum heating of the mixture at 105° C. for 7 hours for 3 to 4 days.
